(19) United States
(12) Patent Application Publication
(10) Pub. No.: US 2023/0378668 A1
(43) Pub. Date: Nov. 23, 2023

(54) Marker strip and a series of electrical appliances with a marker strip

(71) Applicant: Weidmüller Interface GmbH & Co. KG, Detmold (DE)

(72) Inventors: Faysal DOGAN, Horn-Bad Meinberg (DE); Andreas WIENEKE, Lemgo (DE); Tobias Sondermann, Paderborn (DE)

(21) Appl. No.: 18/307,916

(22) Filed: Apr. 27, 2023

(30) Foreign Application Priority Data
May 20, 2022 (DE) 10 2022 112 750.8

(51) Int. Cl. H01R 9/26; G09F 3/12; B29C 48/16; B29C 48/00

(52) U.S. Cl. CPC H01R 9/2683; G09F 3/12; B29C 48/16; B29C 48/0022; B29L 2031/744

(57) ABSTRACT

A marker strip has a strip-shaped labelling strip formed of a first plastic material, which can be labelled on a first labelling side using a printer. A second side of the strip opposite the first side has a plurality of marker latching profiles formed of a second plastic material. The profiles are configured for latching in marker latching receptacles of serially arranged electrical devices. The marker strip has a main direction of extent and the latching profiles are arranged in the main direction of extent in a grid dimension on the second side of the labelling strip. The grid dimension in which the latching profiles are distributed on the second side of the labelling strip is smaller than or equal to 2 mm.

This application claims priority of DE 10 2022 112 750.8 filed May 20, 2002. The entire content of this application is incorporated herein by reference.

### BACKGROUND OF THE INVENTION

The invention relates to a marker strip and a series of electrical devices with a marker strip.

Such a marker strip is known from WO 2016/037874 A1 and DE 10 2015 109 020 A1. DE 20 2012 103 309 A1 discloses cross-connector combs for series terminals.

If a multiplicity or a plurality of electrical devices such as series terminals are arranged in series on a mounting base, each device having a latching profile, in particular a marker latching receptacle so that a latching duct is formed when the devices are flush in the region of the marker latching receptacles, it makes the marking process easier if, instead of a multiplicity of fully separate marker elements, marker elements connected to one another in a strip-shaped manner are used. For example, in order to mark a series terminal arrangement on a supporting rail, it is then only necessary to place the marker strip above the region of serially arranged latching profiles of the series terminals and then push from above onto the individual marker elements so that a secure latching of the marker elements on the devices, in particular the series terminals, is performed. The marker strip or its marker elements should be suitable in particular for printing using a thermal transfer technique and its limiting conditions.

For example, injection molding processes are used to produce such marker strips. Strips with a defined length of, for example, eight marker elements, are produced which are then joined together in order to be able to equip a roll with a long marker strip from which marker strips with a desired quantity of marker elements can then be cut to length. It is particularly difficult to manufacture a superordinate “continuous strip” for rolling into a roll reliably and without offset in the grid of individual injection-molded strips.

According to WO 2016/037874 A1 or DE 10 2015 109 020 A1, the marker strip has regions formed of at least two different plastic materials of differing hardnesses. The latching profile of each marker element is formed of a harder plastic material and the marker plate is formed, at least in the region of the labelling field, of a softer plastic material.

The marker strip is preferably initially produced using the extrusion process. It is preferably manufactured in a multi-component, in particular a two-component, coextrusion process.

In such a manner, it is possible to use plastics of differing hardnesses in each case for the regions of the marker plate with the labelling field on one hand and the latching profile on the other hand. The two-component coextrusion process is a reliable and low-cost process, in particular in comparison with injection molding. By means of extrusion, a continuous strip can be easily manufactured for winding onto a roll. With coextrusion, the marker strips or their marker elements can be used in particular for printing using the thermal transfer technique.

According to the particularly preferred variant, it is particularly advantageous if the latching profile of each marker element is formed of the harder plastic material in order to be able to latch it effectively and securely on the respective electrical device. It is furthermore advantageous if the marker plate is formed of the softer plastic material at least in the region of the labelling field. It can thus be printed more precisely. The softer material facilitates automatic adjustment to the print head and is also gentler on the print head than a harder material. Sink marks are also prevented, and it is conceivable to design the printable regions to be longer since they tilt less easily in the region of the print head and/or do not lift up from the heating strip. It is furthermore possible to select a material which is particularly well suited to printing without having to take account of the fact that the material is hard enough for the latching function which the latching webs or latching profiles perform.

It is also alternatively or additionally particularly advantageous if the connecting region between the marker elements is formed in each case of the softer plastic region. This makes it possible to balance out smaller tolerances which arise as a result of the process of arranging the electrical devices in series by means of corresponding pulling or compression of this region at the mounting location. Winding onto a roll is furthermore facilitated.

It is nevertheless the case that, in the case of different grid dimensions, the softer region must be lengthened or compressed to a relatively significant degree in order to latch the marker strip in the marker duct.

### SUMMARY OF THE INVENTION

The primary object of the present invention is to minimise the problem discussed above. The invention achieves this object through a marker strip which has a strip-shaped labelling strip formed of plastic material which can be labelled on a first or labelling side—using a printer. On a second side opposite the first side, a multiplicity of marker latching profiles formed of plastic material are configured for latching in marker latching receptacles of serially arranged electrical devices. The marker strip has a main direction of extent and the latching profiles are arranged in the main direction of extent X in a grid dimension XR on the second side of the labelling strip. The grid dimension XR is smaller than or equal to 2 mm.

The very small grid dimension XR of the latching profiles on the second side of the labelling strip leads to it being possible to use a marker strip of one design to mark electrical devices with a wide range of widths.

The grid dimension XR at which the marker latching receptacles are distributed on the second side of the labelling strip is smaller than or equal to 1.8 mm and larger than 1.2 mm, for example, =1.5 mm.

The marker strip can be formed of a single plastic material in its entirety in all regions. It can be manufactured using an extrusion process. It can also be manufactured using an injection molding process. It can be formed with a uniform material from a single plastic material, e.g. if contact-free marking technologies, such as lasers, are used for labelling, which is to be understood in the widest sense as marking of all kinds. Other printing methods of all kinds can, however, also be used for labelling.

The marker strip can also be manufactured using a coextrusion process or an injection molding process from two plastic materials, wherein the labelling strip can be manufactured from a first, softer plastic material and the marker latching profiles can be manufactured from a second, harder plastic material so that on one hand good labelling and on the other hand good fastening of the marker strip on the electrical appliance are possible.

According to a preferred embodiment, the respective latching profile has one, two or more latching webs arranged in a joint plane. Alternatively, however, only one latching web is provided for each latching profile and the latching webs are then distributed overall e.g. alternately on the “right” and “left” on the marker strip.

According to a further configuration, one or more perforations can be provided in an identical grid dimension to the latching profiles, in particular for better adjustment to the marking length of the strip material.

The invention thus also provides a combination of a series of electrical devices and a marker strip wherein the electrical devices have in each case a marker latching receptacle, wherein several latching receptacles form a latching duct over several electrical devices in series into which the latching profiles engage, and wherein more than a single latching profile engages in one of the marker latching receptacles of the serial devices. For example, two or more of the latching profiles can engage in only one respective latching receptacle.

The relatively small grid dimension XR of the latching profiles on the second side of the labelling strip also leads to it being possible to use a marker strip of one design for marking electrical devices with a wide range of widths.

The grid dimension XR at which the individual latching profiles are distributed on the second side of the labelling strip in the main direction of extent of the marker strip is less than half the size of the smallest dimension, in particular the grid dimension, of the electrical devices which can be arranged in series in the main direction of extent or in the series direction of the electrical devices.

In addition, the individual walls of the marker latching receptacles individual latching profiles are oriented with one of the walls slightly obliquely with respect to the X-Y-plane in which the latching profiles substantially extend. This is enabled as a result of the small grid dimension such a sloping in the region of the walls can occur.

### BRIEF DESCRIPTION OF THE FIGURES

The invention will be described in greater detail below with reference to the accompanying drawing, in which:

FIGS. 1a and 1b are top and bottom perspective views, respectively, of a marker strip according to the invention;

FIGS. 1c, 1d, 1e, and 1f are bottom plan, front elevation, top plan and side elevation views, respectively, of the marker strip of FIGS. 1a and 1b;

FIG. 2 is a side view of a marker strip according to the invention inserted into a marker receptacle of a partially represented housing shown in cross-section;

FIG. 3a is a sectional view through the region of a marker duct formed from marker receptacles of serially arranged housings of electrical devices into which duct a marker strip is inserted;

FIGS. 3b-3e are sectional views analogous to FIG. 3a with other series of housings for electrical devices, respectively;

FIG. 4a is a perspective view of the region of the marker duct formed from marker receptacles of serially arranged housings of electrical devices, into which duct a marker strip is to be inserted;

FIGS. 4b-4e are perspective views analogous to FIG. 4a with other series of electrical devices, respectively;

FIGS. 5a and 5b are bottom perspective views of a second configuration of a marker strip according to the invention;

FIG. 6a is a bottom perspective view of a third configuration of a marker strip according to the invention;

FIGS. 6b and 6c side view and sectional views, respectively, of the third configuration of the marker strip of FIG. 6a; and

FIGS. 7a-7e are perspective views analogous to FIGS. 4a-4e, respectively, but showing an alternative marker strip.

### DETAILED DESCRIPTION

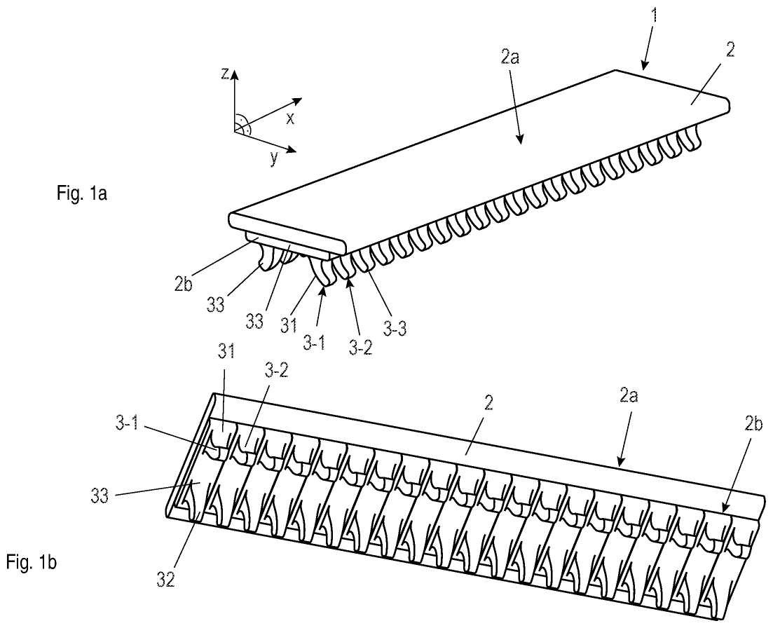

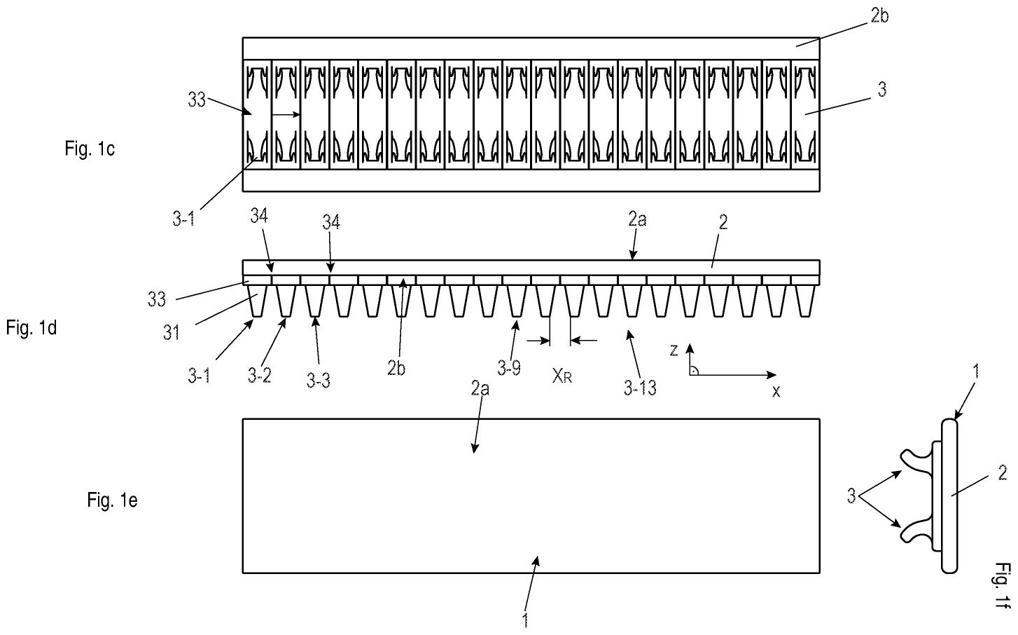

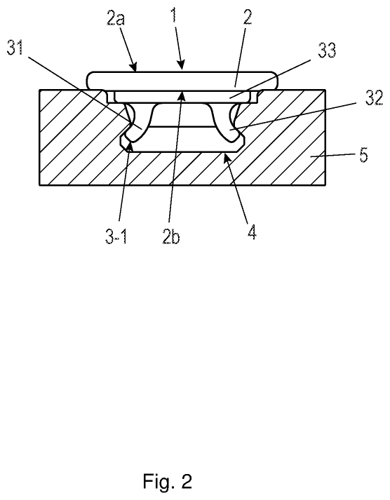

FIGS. 1a to FIG. 1e show a marker strip 1 which has a strip-shaped labelling strip 2 formed of a first plastic material which can be labelled on a first labelling side 2a using a printer and which has on the second side 2b opposite the first side a multiplicity of latching profiles 3 or 3-1, 3-2, 3-3 . . . . The latching profiled are formed of a second plastic material and are configured for latching in a corresponding marker receptacle 4 or 4a, 4b, 4c, . . . of an electrical device 5 or 5a, 5b, 5c also shown in FIG. 2. The electrical device 5 is of the type that can be arranged in series such as a disc-shaped series terminal or a disc-shaped electronic housing. A part of a housing of the device is shown in FIG. 2, wherein the housing can preferably have electrical components such as a connection device for a conductor and/or a busbar and/or an electrical component, etc.

The marker strip 1 can be manufactured and provided in the form of a roll material and is cut to length for mounting on a housing series in accordance with the length of the series. The marker strip 1 can, however, also be offered as pieces/webs, preferably in the case of the planned use of contact-free marking technologies. Webs of various lengths that tend to be short can also be manufactured.

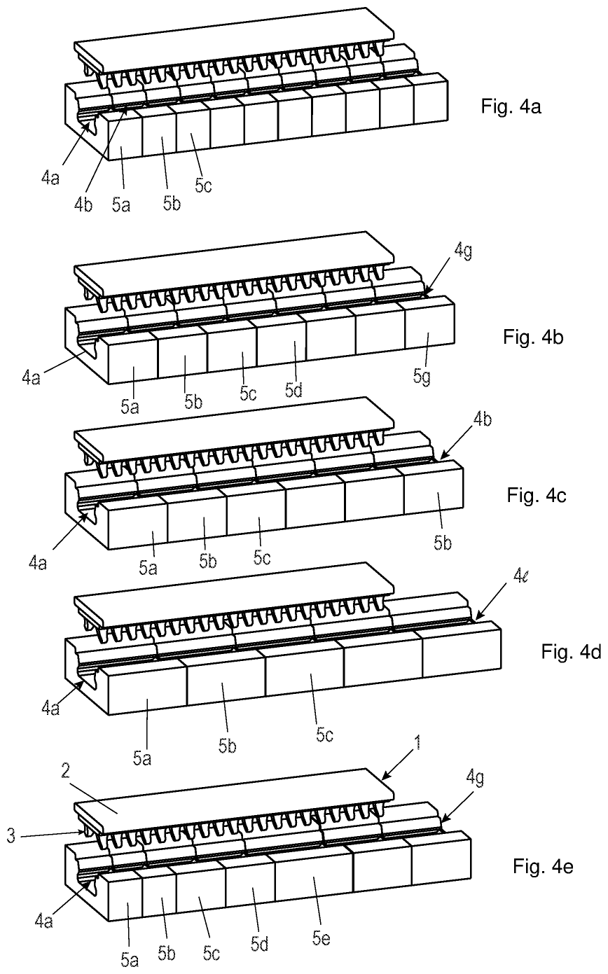

The main direction of extent of the marker strip 1 in the series direction is marked by X. For latching onto one of the devices 5 in each case, the marking strip 1 which is cut to length should be moved substantially perpendicular thereto in a latching-on direction −Z as also shown in FIGS. 4a-4e. The labelling strip 2 extends substantially in an X-Y plane perpendicular to the latching-on direction Z.

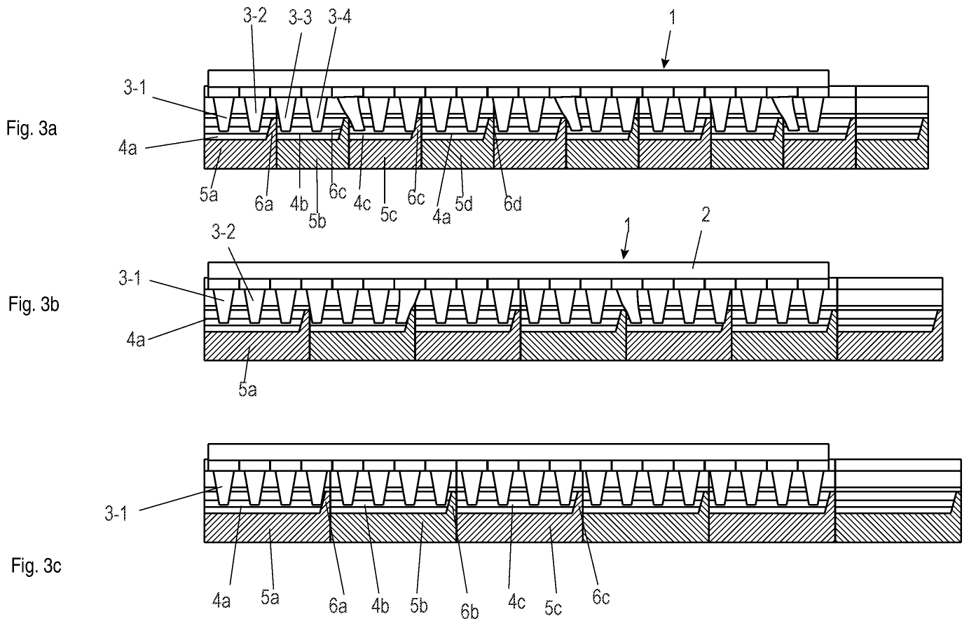

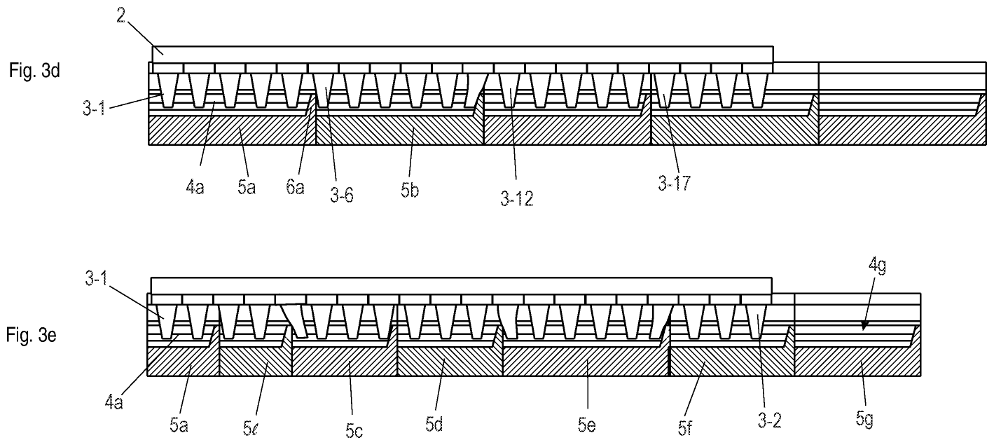

The respective latching profile 3-1, 3-2, 3-3, . . . is formed from one or more latching webs. In the illustrated embodiment, two hook-shaped latching webs 31, 32 are provided in a plate-like base region 33 which adjoins the second side 2b of the labelling strip. The hook-shaped latching webs 31, 32 of the respective latching profile 3-1, 3-2, 3-3, are formed to engage into a correspondingly shaped marker latching receptacle 4a, 4b, 4c, . . . of the electrical devices 5 so that they are held in a latching manner on the electrical device 5 after latching on as shown in particular in FIGS. 2 and 3a-3e.

The latching profiles 3-1, 3-2, 3-3, . . . are in series or distributed in a relatively small grid dimension XR as shown in FIG. 3a. The grid dimensions XR is preferably of less than 2 mm on the second side 2b in the main direction of extent X of the labelling strip 2. They are preferably directly in series and separated from one another close to the labelling strip 2 only by a narrow slot 34. The grid dimension XR thus generally corresponds with the width of the base or the plate-like base region 33 in the X-direction.

The marker strip 1 can be manufactured using an extrusion process, in particular or also using a coextrusion process in which the labelling strip 2a is formed from a first plastic material, and a continuous “latching strip” is formed from a second plastic material, with the strips continuously and jointly extruded.

The “latching strip”, from which the individual latching profiles 3-1, 3-2, 3-3, . . . are formed, is then separated into the individual latching profiles 3-1, 3-2, 3-3, . . . by cuts or punches which preferably penetrate through the second plastic material or the latching strip perpendicular to the longitudinal extent of the latching strip. The individual latching profiles 3-1, 3-2, 3-3, . . . are formed in such a manner.

Other manufacturing methods are, however, also conceivable.

The first plastic material of the labelling strip 2 is preferably a softer plastic material and the second plastic material is a harder plastic material. This is a preferred configuration which, however, does not necessarily have to be implemented.

Such a marker strip 1 is clearly apparent in FIGS. 1a to 1e.

Each electrical device 5 includes at least one receptacle 4 for receiving a latching profile 3 of a marking strip. Thus, a series of devices 5a, 5b, 5c, . . . each has at least one latching receptacle 4a, 4b, 4c, . . . . These latching receptacles 4a, 4b, 4c, . . . can in turn each have in the main direction of extent of the series devices 5a, 5b, 5c, . . . a lateral delimiting wall or wall 6a, 6b, 6c, . . . so that, where applicable, an installed marker element in the series cannot slip in the series direction so that there is a clear association between the marking/labelling and the respective electrical device 5a, 5b, 5c. The marker receptacles 4a, 4b, 4c, . . . are flush in the series direction beyond several of the devices 5a, 5b, . . . so that a type of marker duct is formed which is, however, quasi repeatedly in any event partially interrupted by the delimiting walls 6a, 6b, 6c, . . . .

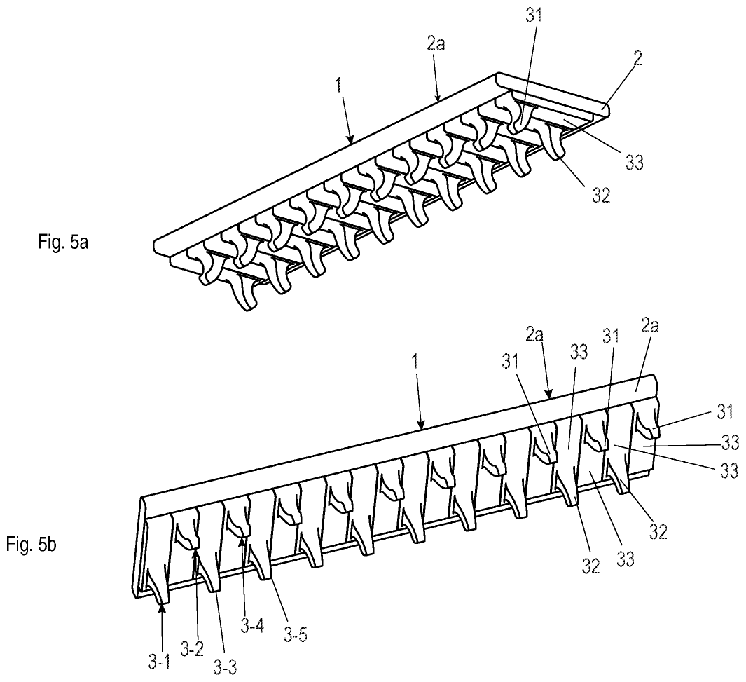

The very small grid dimension XR in which the latching profiles 3-1, 3-2, 3-3, . . . are distributed on the second side of the labelling strip 2 is particularly advantageous since this enables particularly good marking of electrical devices 5a, 5b, 5c, with a wide variety of widths in their series direction as shown in FIGS. 5a-5e, without various marker strips 1 having to be manufactured. The grid dimension XR is smaller than the smallest width in the series direction of the devices 5a, 5b, 5c, . . . to be marked, preferably smaller than or equal to half the width of the devices 5a, 5b, 5c, . . . to be marked. The grid dimension XVR at which the latching profiles 3-1, 3-2, 3-3, . . . are distributed on the second side of the labelling strip 2. The grid dimension XR is preferably less than or equal to (≤) 2 mm. The grid dimension XR preferably lies between 1.3 mm and 1.7 mm. According to one example, the grid dimension XR is around 1.5 mm. This embodiment is represented by way of example in FIG. 1c.

The latching profiles 3a, 3b, 3c, . . . of the devices 5a, 5b, 5c, . . . can taper in a V-shaped manner perpendicular to the series direction as shown in FIG. 1d. The latching profiles 3a, 3b, 3c, . . . can furthermore initially each have, starting from the labelling strip 2, a plate-like base 33 and two latching hooks 31, 32 extending at an angle away from the base for latching in corresponding undercuts of the latching receptacles 4a, 4b, 4c, . . . .

As is apparent in FIGS. 3a to 3e and 4a to 4e, the relatively small grid dimension XR of the latching profiles 3-1, 3-2, 3-3, . . . on the second side of the labelling strip 2 makes it possible to use a marker strip 1 of one design to mark electrical devices 5a, 5b, 5c, . . . with a wide range of widths. The grid width of the electrical devices 5a, 5b, 5c, . . . is thus, for example, around 3.5 mm. As is apparent, the marker strip 1 with the latching profiles 3-1, 3-2, 3-3, . . . in a grid width of 1.5 mm can nevertheless be very effectively fastened on the series constituted by the electrical devices 5a, 5b, 5c, . . . . It is only the case that in the region of individual walls 6a, 6b, 6c, . . . individual latching profiles 3-1, 3-2, 3-3, . . . (in FIG. 3a the latching profile 3-5, for example) can possibly be slightly obliquely oriented by the respective wall 6a, 6b, 6c, . . . . For this purpose, they are slightly slanted or slightly bent, but they nevertheless fit in a latching manner and possibly in a slightly clamping manner in the marker duct which has formed from the latching receptacles 4a, 4b, 4c, . . . arranged in rows across the devices 5a, 5b, 5c, . . . also arranged in row.

An analogous situation is shown in FIGS. 3b and 3d, in which the grid width of the devices 5a, 5b, 5c, . . . is 5.1 mm or 8.1 mm.

In the row of FIG. 3d, the grid width of the latching profiles 3-1, 3-2, 3-3, . . . is around 6.1 mm, such that it is possible to mark several of the devices 5a, 5b, 5c, . . . one after the other without a latching profile 3-1, 3-2, 3-3, . . . striking one of the walls 6a, 6b, 6c, . . . and being slanted.

FIG. 3e shows a series of electrical devices 5a, 5b, 5c, 5d, . . . of varying grid width (purely by way of example twice 3.5 mm, then twice 5.1 mm, then 8.1 mm, then twice 6.1 mm). Such series of electrical devices 5a, 5b, 5c, . . . with a partially different width can also be reliably marked with the marking strip 1 with the latching profiles 3-1, 3-2, 3-3, . . . of a very small grid width.

FIGS. 4a to 4e illustrate an analogous situation wherein the marker strips which have been cut to length are shown prior to latching in a spatially spaced apart manner over the devices 5a, 5b, 5c, 5d, . . . arranged in rows.

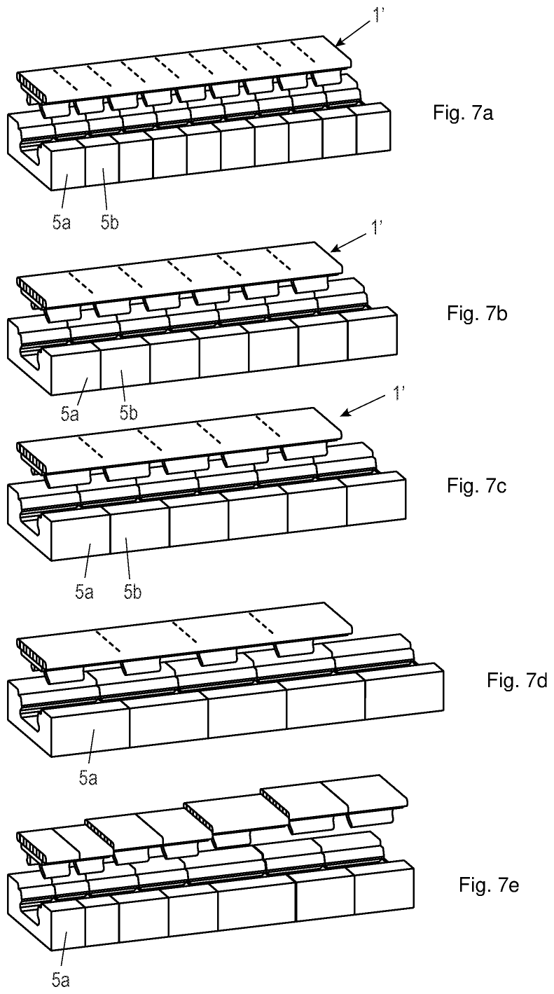

FIGS. 7a to 7e illustrate that, in contrast to the invention, the prior art marker strips 1′ with latching profiles with very different grid widths were to be manufactured, the grid dimension of which in the region of the latching profiles would have to correspond to the series terminals to be marked (3.5 mm, 5.1 mm, 6.1 mm, 8.1 mm). This effort is significantly reduced according to the invention so that quasi only a single type of marker strip 1 with a single grid dimension XR of latching profiles 3-1, 3-2, 3-3, . . . has to be manufactured.

It is also advantageous if the labelling strip 2 is entirely or partially formed of the softer material. This material can be conducted through the region of a print head more easily and with greater precision.

In order to mark a series terminal arrangement on a supporting rail, it is then only necessary to place the marker strip 1 above the region of serially arranged marker latching receptacles 4a, 4b, 4c, . . . of the series terminals and then push it into these from above so that a secure latching of the latching profiles 3-1, 3-2, 3-3, . . . on the devices, in particular on the housings of the devices, is performed as shown in FIG. 3a. The marker strip 1 can then, or in advance, be correspondingly cut to length from a continuous strip such as on a roll or a longer web.

According to FIGS. 1a to 4e, the respective latching profile 3-1, 3-2, 3-3, . . . has at least the two latching webs 31, 32 arranged in a joint plane which is oriented perpendicular to the series direction X. Here, according to FIGS. 1a to 4e and 6, two of the latching webs 31, 32 are connected in the plate-like base region 33.

However the latching webs 31, 32 can alternatively be arranged in planes offset with respect to one another. As shown in FIGS. 5a and 5b, only one of the latching webs 31, 32 is provided for each plate-like base region 33. In addition, the respective two latching webs 31, 32 are arranged in an alternating manner in planes offset with respect to one another. They can then be arranged on two longitudinal sides of the marker strip 1 in the respective grid dimension in an alternating manner on the base regions 33 which follow one another in the main direction of extent X. According to FIGS. 5a and 5b, regions formed of two plastic materials with different harnesses are in turn provided.

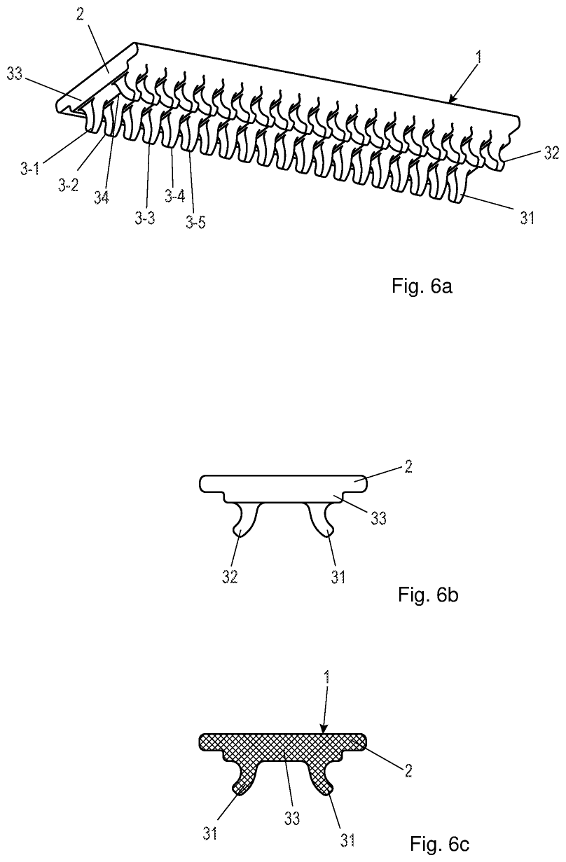

According to FIGS. 6a-6c, in contrast, the entire marker strip 1 is formed of a single material. The structure otherwise corresponds to FIG. 1. The labelling strip 2 is thus manufactured from the same material as the latching profiles 3-1, 3-2, etc.

This can also be provided according to FIGS. 1a to 5b. The marker strip of FIG. 6 could in turn alternatively also be formed of two materials. More than two materials could also be used.

What is claimed is:

1. A marker strip comprising,
a strip-shaped labelling strip formed of plastic material and including a labelling first side and a second side opposite said first side and including a plurality of marker latching profiles formed of plastic material and configured for latching in marker latching receptacles of serially arranged electrical devices, said marker strip having a main direction of extent with said latching profiles arranged in the main direction of extent in a grid dimension less than or equal to 2 mm.

2. The marker strip as defined in claim 1, wherein the grid dimension is less than or equal to 1.8 mm and greater than 1.2 mm.

3. The marker strip as defined in claim 2, wherein the grid dimension is 1.5 mm.

4. The marker strip as defined in claim 1, wherein each latching profile has at least one latching webs.

5. The marker strip as defined in claim 4, wherein two latching webs are arranged in a joint plane which is oriented perpendicular to the main direction X.

6. The marker strip as defined in claim 4, wherein said latching web are distributed offset individually with respect to one another to the left and right on said marker strip in the grid dimension.

7. The marker strip as defined in claim 4, each latching web is attached to a plate-like base region.

8. The marker strip as defined in 7, wherein said plate-like base regions of adjacent marker latching profiles are separated from one another by a slot.

9. The marker strip as defined in claim 4, wherein said latching webs taper away from the respective plate-like base region.

10. The marker strip as defined in claim 1, wherein said marker strip is manufactured as a web in such a manner that shorter marker strips of various lengths can be cut to length from said web.

11. The marker strip as defined in claim 1, wherein said marker strip is manufactured as a roll in such a manner that shorter marker strips of various lengths can be cut to length from the roll.

12. The marker strip as defined in claim 1, wherein said marker strip contains at least one perforation in the grid dimension.

13. The marker strip as defined in claim 1, wherein said marker strip is manufactured from a single plastic material.

14. The marker strip as defined in claim 1, wherein said marker strip is manufactured from two plastic materials, said labelling strip being manufactured from a first plastic material and said latching profiles being manufactured from second plastic material harder than said first plastic material.

15. The marker strip as defined in claim 1, wherein said marker strip is manufactured in one of a coextrusion process and an injection moulding process.

16. An electrical assembly, comprising
(a) a series of electrical devices and
(b) a marker strip including a strip-shaped labelling strip formed of plastic material and including a labelling first side and a second side opposite said first side and including a plurality of marker latching profiles formed of plastic material and configured for latching in marker latching receptacles of serially arranged electrical devices, said marker strip having a main direction of extent with said latching profiles arranged in the main direction of extent in a grid dimension less than or equal to 2 mm, said electrical devices each containing a latching receptacle into which said latching profiles engage and wherein, in a series direction of the electrical devices, more than a single latching profile engages in one of said marker latching receptacles.

17. An electrical assembly as defined in claim 16, wherein the grid dimension is less than half the size of the smallest dimension of said electrical devices.

18. An electrical assembly as defined in claim 16, wherein said latching receptacles are defined by individual walls and wherein individual latching profiles are oriented by one of the walls obliquely with respect to a plane in which said latching profiles extend.
